(19) United States
(12) Patent Application Publication
(10) Pub. No.: US 2025/0353112 A1
(43) Pub. Date: Nov. 20, 2025

(54) JET NOZZLE HAVING AN ABSORPTION PORTION FOR ABSORBING BACK-REFLECTED RADIATION

(71) Applicant: TRUMPF Laser- und Systemtechnik SE, Ditzingen (DE)

(72) Inventors: Nicolai SPEKER, Pleidelsheim (DE); Björn SAUTTER, Leonberg (DE); Andreas SCHOLZ, Taunusstein (DE); Stefan BELITZ, Stuttgart (DE); Arne STECK, Remseck am Neckar (DE); Jakob SPIECKER, Stuttgart (DE); Fabian GOETZELMANN, Leonberg (DE); Tim HESSE, Ditzingen (DE); Holger BRAUN, Renningen (DE)

(21) Appl. No.: 19/280,151

(22) Filed: Jul. 25, 2025

Related U.S. Application Data
(63) Continuation of application No. PCT/EP2024/051303, filed on Jan. 19, 2024.

(30) Foreign Application Priority Data
Jan. 27, 2023 (DE) 10 2023 102 043.9
Sep. 4, 2023 (DE) 10 2023 123 706.3

(51) Int. Cl. B23K 26/14; B23K 26/144

(52) U.S. Cl. CPC B23K 26/1488; B23K 26/144

(57) ABSTRACT

A jet nozzle for laser cladding along a direction of advance includes a light channel for conducting at least one laser beam directed onto a workpiece, and an outer structure surrounding the light channel at least in sections. The outer structure extends from a flange portion to a distal region that is formed by a mouth of the jet nozzle from which the at least one laser beam exits. The light channel forms an absorption portion for absorbing back-reflected radiation of the at least one laser beam from the workpiece.

### CROSS REFERENCE TO RELATED APPLICATIONS

This application is a continuation of International Application No. PCT/EP2024/051303 (WO 2024/156622 A1), filed on Jan. 19, 2024, and claims benefit to German Patent Application No. DE 10 2023 123 706.3, filed on Sep. 4, 2023 and to German Patent Application No. DE 10 2023 102 043.9, filed on Jan. 27, 2023. The aforementioned applications are hereby incorporated by reference herein.

### FIELD

Embodiments of the present invention relate to a jet nozzle for laser cladding along a direction of advance.

### BACKGROUND

Laser cladding is used in the fields of repair, coating, and/or joining technology, for example. A distinction can be made between conventional laser cladding techniques (laser metal deposition (LMD), direct metal deposition (DMD) or direct energy deposition (DED)), and high-speed laser cladding (high-speed laser metal deposition (HS-LMD) or extreme high-speed laser application (EHLA)). HS-LMD methods are described, for example, in the disclosure documents DE 10 2011 100 456 B4 and DE 10 2018 130 798 A1. Another method for laser cladding is known from the Chinese patent application CN 109175372 A.

A functional layer can be applied to a workpiece by means of laser cladding. This generally increases the load-bearing capacity of the workpiece processed by means of laser cladding compared to an unprocessed workpiece. The functional layer can serve as a wear protection layer, for example. The application of the functional layer is based on a melting of a workpiece surface, an application of a powdered filler material, and a subsequent cooling so that a matrix structure with hard material particles is materially bonded to the material surface. Laser cladding therefore engages with the inner material structure of the workpiece and changes it. Under certain circumstances, this can result in imperfections in the internal material structure. These can impair the desired increase in resilience. The imperfections can be of a microscopic nature, which is why they can only be identified with great effort.

### SUMMARY

Embodiments of the present invention provide a jet nozzle for laser cladding along a direction of advance. The jet nozzle includes a light channel for conducting at least one laser beam directed onto a workpiece, and an outer structure surrounding the light channel at least in sections. The outer structure extends from a flange portion to a distal region that is formed by a mouth of the jet nozzle from which the at least one laser beam exits. The light channel forms an absorption portion for absorbing back-reflected radiation of the at least one laser beam from the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a jet nozzle during laser cladding according to some embodiments;

FIG. 2 shows a side view of a jet nozzle according to some embodiments;

FIG. 3 shows a perspective view of the jet nozzle from FIG. 2 according to some embodiments;

FIG. 4 shows the jet nozzle from FIG. 2 connected to other components according to some embodiments;

FIG. 5 shows a top view of a distal region of the jet nozzle from FIG. 2 according to some embodiments;

FIG. 6 shows a top view of a flange portion of the jet nozzle from FIG. 2 according to some embodiments;

FIG. 7 shows another perspective view of the jet nozzle from FIG. 2 according to some embodiments;

FIG. 8 shows s a perspective sectional view of the jet nozzle from FIG. 2 according to some embodiments;

FIG. 9 shows a further perspective sectional view of the jet nozzle from FIG. 2 according to some embodiments;

FIG. 10 shows a further sectional view of the jet nozzle and the workpiece according to some embodiments;

FIG. 11 shows a further perspective sectional view of the jet nozzle with an angled end face according to some embodiments;

FIG. 12 shows a longitudinal sectional view through a jet nozzle with a smooth inner end portion according to some embodiments;

FIG. 13 shows the jet nozzle with a process gas unit in a top view of the distal region according to some embodiments;

FIG. 14 shows a further embodiment of the jet nozzle with a geometrically adapted mouth of the nozzle in a side view; and

FIG. 15 shows a further embodiment of the jet nozzle with a geometrically adapted mouth of the nozzle in a top view.

### DETAILED DESCRIPTION

Embodiments of the present invention provide an improved jet nozzle for laser cladding along a direction of advance. Embodiments of the invention can increase the welding quality of a deposited functional layer and of the workpiece as a whole, and to reduce or avoid imperfections in a welded joint between a powdered filler material and a material surface. The imperfections can be bonding defects between the material surface and the applied functional layer or between individual applied functional layers. The imperfections can also be pores, i.e., air pockets, which occur within the applied functional layer, or between the applied functional layer and the material surface. Particularly if the material surface is a cast material, pores can occur more frequently. The imperfections can also be cracks that run vertically to the material surface within the applied functional layer. The imperfections can also result from the fact that powder particles, in particular carbides, of the powdered filler material dissolve in a matrix material of the powdered filler material, which leads to the matrix material becoming brittle. Embodiments of the invention can provide a reliable jet nozzle that is resistant to thermal stresses. Embodiments of the invention provide the jet nozzle configured in such a way that it ensures reliable and precise laser cladding over a very high number of cycles.

Accordingly, a jet nozzle for laser cladding along a direction of advance is provided, which has a light channel for conducting at least one laser beam directed onto a workpiece. Laser cladding can be a method for high-speed laser metal deposition (HS-LMD). The direction of advance is the direction along which the jet nozzle moves relative to the workpiece. It can result from a movement, in particular a rotational movement, of the workpiece, from a movement of the jet nozzle, or from a superposition of both movements. The direction of advance and the correlating advancement movement can be constant over the course of the process. Alternatively, they can vary with the respective process stage. The workpiece can be a rotationally symmetrical workpiece, such as a brake disk, a hydraulic cylinder, a pressure roller, or a plain bearing. The laser beam can shine through the light channel. It can be provided by a laser source, from which the laser beam is guided by means of an optical fiber cable to a laser system that splits the laser beam via a collimating lens and focuses it in line with the process via laser optics before it enters the jet nozzle. The light channel can be a hollow channel that runs through the entire jet nozzle along a longitudinal direction. In addition to the laser beam, a process gas can also be directed to the workpiece surface through the light channel.

The jet nozzle further has an outer structure surrounding the light channel, which extends from a flange portion to a distal region that is formed by a mouth of the nozzle from which the laser beam exits. The outer structure can comprise a powder unit. The powder unit can be part of the mouth of the nozzle. The mouth of the nozzle is the part of the jet nozzle facing the workpiece. The end portion of the mouth of the nozzle forms the distal region. This is the part of the mouth of the nozzle that is closest to the workpiece. On the portion facing away from the workpiece, the jet nozzle has a proximal region and the flange portion. The proximal region and the flange portion are the part of the jet nozzle facing away from the workpiece. The nozzle can be coupled to a further component of the laser system, such as laser optics or a process unit, via the flange portion. The outer structure can be a component made of a uniform material and can have a hollow channel along its longitudinal direction which represents the light channel.

The light channel forms an absorption portion for absorbing back-reflected radiation of the laser beam from the workpiece. The absorption portion may have a geometry that favors the absorption of the back-reflected radiation. The absorption portion can extend variably in a circumferential direction around the light channel. It can also extend variably in a longitudinal direction of the light channel. In particular, no absorption portion 40 is formed in the distal region of the mouth of the nozzle in order to facilitate better cleaning of the mouth of the nozzle. The shape of the absorption portion can be adapted to the expected back-reflected radiation. The absorption portion can be formed of the same material as the remaining jet nozzle. It can also have a coating. The laser radiation absorbed by the absorption portion can be dissipated by a cooling system interacting with the absorption portion.

The jet nozzle can thus provide increased variability in (i) laser beam guidance, (ii) the use of a powdered filler material, (iii) heat management, and/or (iv) protection of the laser system including the jet nozzle. It enables the provision of several independent process zones with high precision. The process zones can be divided into zones for laser cladding and zones for pre- and/or post-processing. In the zones for laser cladding, an interaction takes place between at least one laser beam and a powdered filler material. The pre- and/or post-processing can be the cleaning of the material surface, the pre-heating of the material surface before the powdered filler material is applied, the post-heating of the material surface after the powdered filler material has been applied, or a combination thereof. During pre- and/or post-processing, the laser beam can strike the workpiece without interacting with the powdered filler material. The independent process zones can increase the welding quality and thus the resilience of the applied functional layer, in particular the wear protection layer, and of the workpiece as a whole. An additional process gas can stabilize the process zones and increase the precision of laser cladding as well as the service life of the jet nozzle.

In particular, the jet nozzle can reduce the occurrence of bonding defects. This is because bonding defects can occur if the surface heated by the laser beam, such as when the workpiece or a previously welded-on functional layer, has not been sufficiently heated. This lack of heating can be the result of the laser power of a single laser beam being kept low to avoid overheating the powdered filler material. The increased variability of the laser beam guidance, the increased variability of the application of a powdered filler material and/or the increased variability of the heat management of the jet nozzle can reduce or even prevent the occurrence of bonding errors, in particular by the jet nozzle with the absorption portion contributing to the heat management and protection of the laser system in such a way that several process zones are made possible.

In particular, the jet nozzle can also reduce the occurrence of pores between the welded-on functional layer and the surface heated by the laser beam. This is because pores can occur when lamellae in the workpiece, in particular graphite lamellae, are vaporized by the laser radiation. Pores can also occur if the surface to be machined has impurities, for example caused by oils, greases, cooling lubricants or oxides, which cannot be completely removed by the welding process. The undesired vaporization of the impurities can be the result of the laser power of a single laser beam being set so high that bonding defects due to insufficient heating can be avoided. The increased variability of the laser beam guidance, the increased variability of the application of a powdered filler material and/or the increased variability of the heat management of the jet nozzle can reduce or even prevent the occurrence of pores, in particular by the jet nozzle with the absorption portion contributing to the heat management and protection of the laser system in such a way that several process zones are made possible.

In particular, the jet nozzle can also reduce the occurrence of cracks in the welded-on functional layer. This is because cracks can occur if a temperature gradient between the highly heated powdered filler material and the less strongly heated workpiece surface is so strong that the material shrinkage that occurs during cooling results in stresses that cause cracks. Cracking can be the result of a laser power of a single laser beam being set so high that bonding defects due to insufficient heating can be avoided. The increased variability of the laser beam guidance, the increased variability of the application of a powdered filler material and/or the increased variability of the heat management of the jet nozzle can reduce or even prevent the occurrence of cracks, in particular by the jet nozzle with the absorption portion contributing to the heat management and protection of the laser system in such a way that several process zones are made possible.

In particular, the jet nozzle can also reduce the dissolution of hard material particles, especially carbides, in the matrix material. The powdered filler material can contain hard material particles, in particular carbides, and a matrix material. The hard material particles should be present undissolved in the welded-on functional layer to increase the load-bearing capacity of the functional layer. However, hard material particles can dissolve if the powdered filler material is exposed to too high a radiation intensity, causing the hard material particles to melt. Dissolved hard material particles cause the welded-on functional layer to become brittle because the matrix material is less ductile, which means that stresses caused by shrinkage, for example, cannot be absorbed by the matrix material when the workpiece is cooled or loaded. The increased variability of the laser beam guidance, the increased variability of the application of a powdered filler material and/or the increased variability of the heat management of the jet nozzle can reduce or even prevent the undesired dissolution of hard material particles, in particular by the jet nozzle with the absorption portion contributing to the heat management and protection of the laser system in such a way that several process zones are made possible.

In particular, the jet nozzle can prevent an adhesion of powder particles to the mouth of the nozzle. In principle, high process heat, reflective laser radiation, and/or a metal vapor plume can cause an adhering or even welding of filler material to the mouth of the nozzle, which can disrupt the gas and powder flows and subsequently impair the process result. The metal vapor plume is a result of the partial vaporization of the material due to the laser cladding. It can lead to scattering and/or absorption of laser radiation and consequently impair the preheating of the workpiece. This can further promote the formation of bonding defects. The increased variability of the laser beam guidance, the increased variability of the application of a powdered filler material and/or the increased variability of the heat management of the jet nozzle can reduce or even prevent the undesired dissolution of hard material particles and the spread of the metal vapor plume, in particular by the jet nozzle with the absorption portion contributing to the heat management and protection of the laser system in such a way that several process zones are made possible.

The absorption portion of the light channel absorbs back-reflected radiation of the laser beam from the workpiece back to the jet nozzle. Back-reflected radiation that damages the jet nozzle can thus be efficiently dissipated. The back-reflected radiation is absorbed by the absorption portion in such a way that the portion of radiation that penetrates into other components of the laser system, such as the laser optics, is reduced or eliminated. This increases process reliability and the precision of the laser beam. The service life of the jet nozzle and the laser system is also increased. The improved properties of the jet nozzle due to the absorption surface enable welding behavior without the aforementioned deficiencies.

In one embodiment, the absorption portion extends from above the distal region to a proximal region adjoining the flange portion. The absorption portion can thus extend over the entire height of the jet nozzle, with the exception of the flange portion and the distal region. Accordingly, back-reflected radiation is absorbed by the absorption portion over a large part of the height of the jet nozzle, which contributes to the efficient heat management and protection of the laser system. For example, the distal region can extend up to 10 mm along the height into the nozzle. Since there is no absorption portion in the distal region, cleaning of the jet nozzle can be made easier.

In one embodiment, the absorption portion has a serrated structure, in particular an irregularly serrated structure, which forms absorption surfaces facing the distal region. The serrated structure may have a Christmas tree-like contour along a longitudinal direction of the light channel. The absorption surfaces can run along a plane that is orthogonal to the longitudinal direction of the light channel. The serrated structure can be formed from the absorption surface and a support surface leading back to the wall of the light channel, so that each serration has a substantially triangular shape. The uniformly serrated structure may have uniform serrations from the distal region to the proximal region. Alternatively, the serrations can become larger from the distal region to the proximal region.

In one embodiment, a powder unit arranged radially outside the light channel is formed in the outer structure for conducting at least one jet of powder to be applied to the workpiece, wherein the powder unit forms a powder portion at the mouth of the nozzle in a circumferential direction around the light channel, which is followed in the circumferential direction by a powder unit-free advance portion. The advance portion can be the portion which faces the direction of advance, i.e., points in the direction of the direction of advance. The advance portion can extend along the circumferential direction around the light channel in an angular range. The region in which the advance portion is formed can correlate with the position and orientation of the powder injectors that apply the powdered filler material to the workpiece. The powder portion and the advance portion can together form the entire circumference of the mouth of the nozzle around the light channel. For example, the powder portion can make up the larger part than the advance portion. In the top view, the powder portion and the advance portion can run closed along an opening of the light channel, for example an opening in the form of an elongated hole.

In one embodiment, the absorption portion is arranged at least in the advance portion, in particular in the circumferential direction. Due to the angle of incidence of the at least one laser beam, the advance portion may be the part of the jet nozzle that is exposed to the highest thermal load. In this respect, arranging the absorption portion at least in the advance portion can further contribute to efficient heat management and protection of the laser system. The absorption portion can, for example, be arranged only in the region of the advance portion or also circumferentially, i.e. 3600 along the circumferential direction.

In one embodiment, the absorption portion extends completely around the light channel in a circumferential direction. In this way, absorption of the back-reflected radiation by the absorption portion is ensured for any arrangement of the jet nozzle relative to the workpiece and the back-reflected radiation resulting from the arrangement. This contributes to efficient heat management and protection of the laser system. Alternatively, it can also be provided that a position of the absorption portion correlates with an inclination provided for the jet nozzle relative to the workpiece. The absorption portion can therefore alternatively not be designed to run all the way around the light channel. Instead, it is specifically positioned in the region where, due to the inclination of the jet nozzle relative to the workpiece, the majority of the back-reflected radiation is directed towards the jet nozzle.

In one embodiment, a longitudinal axis of the light channel along which the laser beam runs is inclined relative to a perpendicular of the workpiece surface in order to increase absorption of the back-reflected radiation by the absorption portion. The laser beam is therefore not aligned orthogonal to the workpiece, in order to absorb back-reflected radiation specifically via the absorption portion.

In one embodiment, an end face of the jet nozzle runs at an angle to the longitudinal axis of the light channel along which the laser beam runs, so that the end face is provided to run in a plane-parallel manner to a workpiece surface. This means that the distance from the mouth of the nozzle to the workpiece can be increased. This reduces the thermal load on the mouth of the nozzle. In addition, the angled end face enables improved shielding gas coverage of the workpiece. This is because the plane-parallel surface of the end face allows a shielding gas flow to emerge orthogonally to the workpiece.

In one embodiment, a surface of the absorption portion increases in a circumferential direction around the light channel from the mouth of the nozzle to the flange portion. This can correlate with the fact that a cross-section of the light channel increases towards the flange portion, whereby the corresponding surface of the absorption portion can also increase. This ensures that emissions in the proximal region are intercepted, further contributing to heat management by protecting the laser optics.

In one embodiment, the jet nozzle can be inclined relative to the workpiece, so that absorption of the back-reflected radiation by the absorption portion can be controlled by means of an inclination. The alignment of the laser beam relative to the jet nozzle can be constant. Thus, the angle of reflection of the back-reflected radiation can be adjusted by the inclination of the jet nozzle. The inclination may interact with the absorption portion to capture as much of the back-reflected radiation as possible from the absorption portion.

In one embodiment, the absorption portion is provided with an absorbent coating. This can help to increase its thermal resilience. It can also increase the thermal conductivity of the absorption portion. This helps to ensure that the absorption portion is not damaged even in the event of increased back-reflected radiation.

In one embodiment, the jet nozzle is manufactured by means of an additive manufacturing process, in particular by means of powder bed fusion. For this purpose, the jet nozzle can be made of copper or a copper alloy, in particular a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion can be formed using selective laser melting (SLM) or selective laser sintering (SLS), for example.

In one embodiment, the mouth of the nozzle has a chamfer by which a part of the mouth of the nozzle is cut off, wherein the chamfer is essentially planar and extends in a plane which is inclined relative to the longitudinal direction of the jet nozzle. The chamfer can cut off the powder portion and the powder portion-free advance portion in the circumferential direction around the light channel. The chamfer reduces the volume of the mouth of the nozzle compared to the embodiment in which no chamfer is provided. This means that the mouth of the nozzle takes up less installation space. The jet nozzle with the chamfer can be used, for example, to coat a brake disk that has a mount that protrudes axially from the functional surface to be coated. The chamfer ensures that the jet nozzle can move flexibly on the functional surface to be coated and can be moved close to the holder. The chamfer can run in the distal region in the manner of a passant on the elongated hole. The passant defines the orientation of the chamfer on the mouth of the nozzle. In the end face of the jet nozzle facing the workpiece, the passant runs along a straight line or an arc that neither intersects nor touches the elongated hole. The distance of the passant from the center of the light channel is greater than the distance of the corresponding portion of the elongated hole from the center of the light channel. The distance between the passant and an outer edge of the elongated hole is selected in such a way that the wall thickness in between ensures sufficient sturdiness and stressability of the jet nozzle.

In one embodiment, the disclosure further relates to a system comprising a jet nozzle according to the disclosure and a workpiece. The jet nozzle is inclined relative to the workpiece such that a longitudinal axis of the light channel along which the laser beam runs deviates from a perpendicular of the workpiece surface, so that absorption of the back-reflected radiation by the absorption portion is increased. The inclination can be realized by a relative movement of the jet nozzle to the workpiece or of the workpiece to the jet nozzle. For example, a workpiece support can be inclined in relation to the jet nozzle. The inclination is adapted to the position of the absorption portion.

In one embodiment, the inclination of the jet nozzle relative to the workpiece is between 2° and 45°, in particular between 3° and 10°. It has been found that these angles of inclination achieve an ideal compromise between the absorption of reflected radiation via the absorption portion and the welding behavior of laser cladding.

In one embodiment, the jet nozzle is adapted to guide the laser beam along the longitudinal direction of the jet nozzle, so that the at least one laser beam is orthogonal to the cross-sectional area. Furthermore, the light channel can be adapted to guide a shielding gas along a radially outer portion to shield a process zone.

The features according to the disclosure contribute partly on their own and partly in combination to overcoming the imperfections of laser cladding mentioned at the outset.

Exemplary embodiments are described below with reference to the figures. In this case, elements that are the same, similar, or have the same effect are provided with identical reference symbols in the different figures, and a repeated description of these elements is omitted in some instances to avoid redundancies.

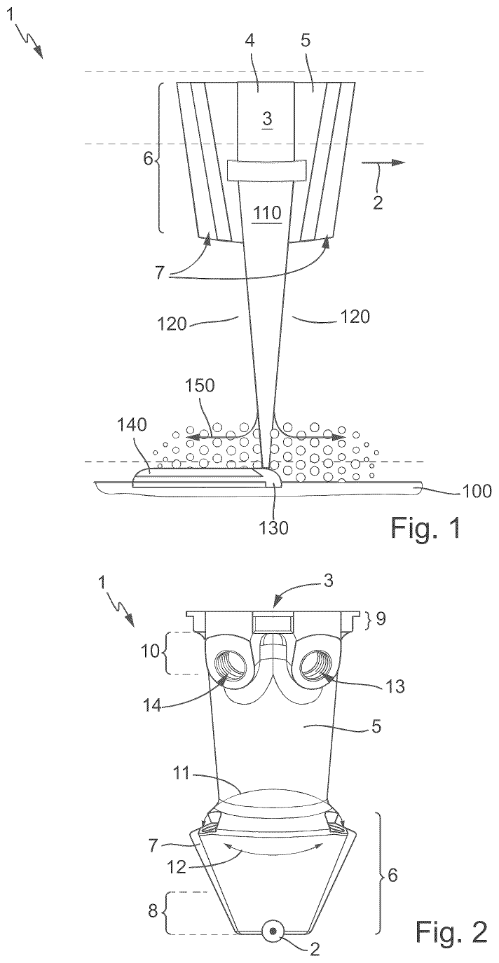

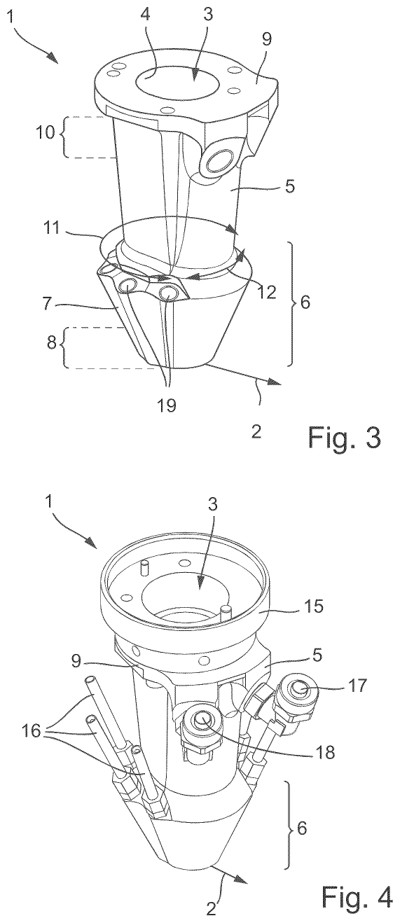

FIG. 1 shows a jet nozzle 1 for laser cladding along a direction of advance 2. The direction of advance 2 is the direction along which the jet nozzle 1 moves relative to a workpiece 100. It can result from a movement, in particular a rotational movement, of the workpiece 100, from a movement of the jet nozzle 1 or from a superimposition of a movement of the workpiece 100 and the jet nozzle 1. The direction of advance 2 and the correlating advancement movement can be constant over the course of the process. Alternatively, they can vary with the respective process stage. The workpiece 100 can be a rotationally symmetrical workpiece, such as a brake disk, a hydraulic cylinder, a pressure roller, or a plain bearing. At least one laser beam 110 emerges from a light channel 3 with a lateral surface 4. The light channel 3 can also be adapted to guide a process shielding gas 150 along a radially outer portion to shield a process zone and prevent oxidation. The light channel 3 is surrounded by an outer structure 5, which has a mouth 6 of the nozzle, which in turn contains a powder unit 7. The powder unit 7 can, for example, have a plurality of injector guides 19 (see FIG. 3), into each of which can be inserted a powder injector 16 (see FIG. 4). As an alternative to the individual injector guides 19, the powder unit 7 can have a powder ring gap channel. A powdered filler material 120 is directed onto the workpiece 100 via the powder unit 7 and the powder injectors 16 arranged therein. The laser beam 110 heats the workpiece 100 in such a way that a molten pool 130 forms on a material surface. In addition, the laser beam 110 heats the powdered filler material 120, which comprises hard material particles and a matrix material. For this purpose, the laser beam 110 can have a reduced core intensity. As soon as the molten pool 130 cools down, a welded-on functional layer 140, for example a wear protection layer, is formed from the hard material particles and the matrix material. The welded-on functional layer 140 makes the material surface more resistant and increases its load-bearing capacity.

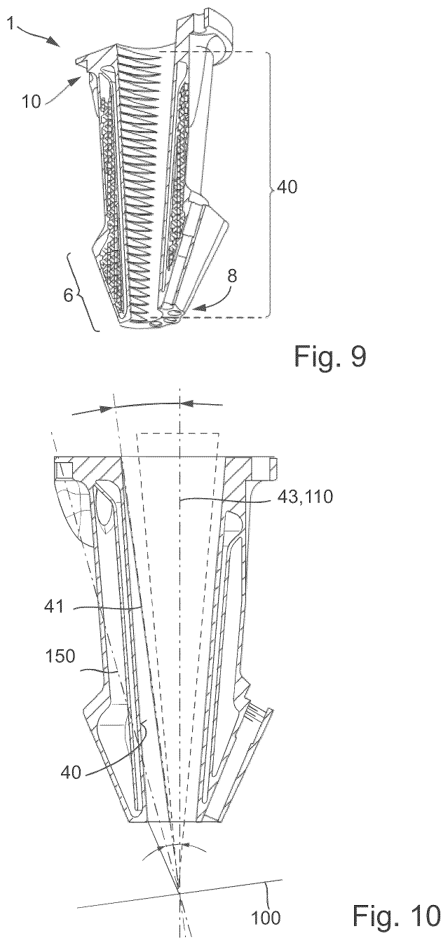

FIG. 2 shows the jet nozzle 1 in a side view, with the direction of advance 2 pointing out of the drawing plane. The jet nozzle 1 can be coupled to other components of a laser system, such as laser optics or a process adapter, via a flange portion 9. A proximal region 10 is attached to the flange portion 9. A coolant inlet 13 and a coolant outlet 14, which are part of a cooling system of the jet nozzle 1 and which project radially from the jet nozzle 1, can be provided at least partially in the proximal region 10. A distal region 8 is formed at the end of the jet nozzle 1 opposite the proximal region 10. The distal region is part of the funnel-shaped mouth 6 of the nozzle. In a circumferential direction around the light channel 3, this has a powder portion 11 in sections, in which the powder unit 7 is arranged. The powder portion 11 is followed in the circumferential direction by a powder unit-free advance portion 12. The advance portion 12 can be designed as a process gas portion 61 (see, for example, FIG. 9), which is part of a process gas unit 60.

FIG. 3 shows a perspective view of the jet nozzle from FIG. 2. The light channel 3 is a hollow channel with a lateral surface 4, within which runs the at least one laser beam 110. The outer structure 5 surrounds the light channel 3 from the flange portion 9 to the distal region 10. The mouth 6 of the nozzle is an essentially funnel-shaped region of the jet nozzle 1. The funnel shape of the mouth 6 of the nozzle serves, among other things, to enable the mouth 6 of the nozzle to form the plurality of injector guides 19 in the region of the powder unit 7. A powder injector 16 (see FIG. 4) is inserted into each of these injector guides 19, which directs the powdered filler material 120 onto the at least one laser beam 110 and/or the workpiece 100 in accordance with the process. The powder unit 7 extends along the powder portion 11, which is followed in the circumferential direction by the powder unit-free advance portion 12. The advance portion 12 is the region of the mouth 6 of the nozzle in which no injector guides 19 are provided, so that no powdered filler material 120 is supplied via this portion. In one embodiment, the advance portion 12 can be shaped as a process gas portion 61, so that a process gas is supplied via this. The jet nozzle 1 can be manufactured by means of additive manufacturing processes, in particular by means of powder bed fusion. For this purpose, the jet nozzle 1 can be made of a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion can be formed using selective laser melting (SLM) or selective laser sintering (SLS), for example.

FIG. 4 shows the jet nozzle 1, to which additional components are attached. A coupling ring 15 is connected to the flange portion 9, which attaches the jet nozzle 1 to the connected unit, for example the laser optics or the process adapter. Powder injectors 16 are inserted into the injector guides 19 of the powder unit 7. The powdered filler material 120 is conveyed by means of the powder injectors 16 and applied to the workpiece 100 with the provided focus. The individual powder injectors 16 can use different powder foci in relation to each other. Alternatively, the powder injectors 16 can be directed to the same focus point. The powder injectors 16 are arranged in the provided injector guides 19 of the powder unit 7 in the powder portion 11. The advance portion 12 is free of powder injectors 16. An inlet connection 17 is also inserted into the coolant inlet 13 and an outlet connection 18 is inserted into the coolant outlet 14. These connect the coolant inlet 13 and the coolant outlet 14 to a coolant circuit.

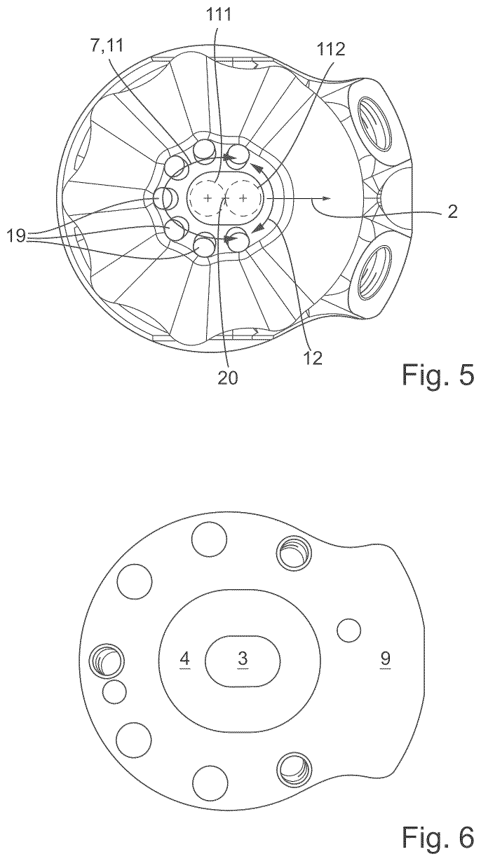

FIG. 5 shows the jet nozzle 1 in a top view of the distal region 8. The cross-sectional area of the light channel 3, which is orthogonal to the longitudinal direction of the jet nozzle 1, deviates from a circular shape and is stretched in the direction of advance 2. In the distal region 8, the cross-sectional area of the light channel 3 is designed in the form of an elongated hole, in which two opposite ends of a rectangular portion are each joined by a partial circular portion. Two laser beams are guided within the light channel 3, a primary beam 111 and a secondary beam 112. The primary beam 111 and the secondary beam 112 can originate from the same optical fiber cable. The laser light provided can be split into a parallel beam via a collimating lens. The beam bundle can, for example, form the primary beam 111 and the secondary beam 112 from a single laser beam using a wedge plate. The respective centers of the primary beam 111 and the secondary beam 112 lie in the direction of advance 2 in a line offset to a center 20 of the light channel 3.

In the present case, the secondary beam 112 lies in front of the primary beam 111 in the direction of advance 2 and does not interact with a powder caustic. The secondary beam 112 can thus be used to preheat the workpiece 100 before the primary beam 111 and the powdered filler material 120 heated by the primary beam 111 strike the workpiece 100. The secondary beam 112 thus creates a first process zone, which serves to preheat the workpiece 100, and the primary beam 111 creates a second process zone, which serves to weld the powdered filler material 120 onto the workpiece 100. These different process zones enable a flawless weld in which no imperfections occur, in particular no bonding defects, pores, cracks and/or dissolution of carbides in the matrix material. It is also possible to guide the secondary beam 112 in the direction of advance 2 after the primary beam 111. Thus, the secondary beam 112 can be used to reheat the workpiece 100, contributing to a more uniform cooling that prevents the occurrence of entrapment or other imperfections.

The primary beam 111 and the secondary beam 112 are arranged in close proximity to each other. The front partial circular portion of the elongated hole in the direction of advance 2 is concentric to the secondary beam 112, while the rear partial circular portion of the elongated hole is concentric to the primary beam 111. A center of the cross-sectional area is eccentric to a center of the primary beam 111 and to a center of the secondary beam 112. A tertiary beam can also be provided so that, for example, the secondary beam is arranged before the primary beam in the direction of advance and the tertiary beam is arranged after the primary beam in the direction of advance. The individual laser beams are guided to each other without shielding, so that there is exactly one light channel 3 with exactly one lateral surface 4, which results in minimal thermal losses.

Because the primary beam 111 in FIG. 5 is arranged behind the secondary beam 112 in the direction of advance 2 without radial offset and the secondary beam 112 serves to preheat the workpiece, it is desirable that the powdered filler material does not interact with the secondary beam 112. This ensures that, on the one hand, the secondary beam 112 can only perform the function of preheating the workpiece and, on the other hand, the powdered filler material is only heated by the primary beam 111 and not by the secondary beam 112. This is achieved by the jet nozzle 1 shaping the powder unit 7 in the region of the mouth 6 of the nozzle in such a way that it forms the powder portion 11 in the circumferential direction around the light channel 3, which is followed in the circumferential direction by the powder unit-free advance portion 12. In addition to the powder unit 7, the process gas unit 60 can also be formed, which forms the process gas portion 61, in which case the advance portion 12 is formed as the process gas portion 61. The advance portion 12 is formed in a region of the mouth 6 of the nozzle facing the direction of advance 2. The powder portion 11 extends along the elongated hole that forms the cross-sectional area of the light channel 3 in the distal region 8. Similar to a circular arc, the powder portion 11 extends along an elongated hole arc, in particular in the shape of a horseshoe, around the light channel 3. The powder portion 11 therefore extends in the circumferential direction around the light channel 3 by a wrap angle of less than 360°, in particular between 90° and 330°, further in particular between 180° and 300°, relative to a center of the light channel. This ensures that the powdered filler material flowing out of the injectors 16, which are inserted in the injector guides 19, only interacts with the primary beam 111. The secondary beam 112 can thus form a process zone independent of the primary beam 111. The powder portion 11 and the advance portion 12 form an elongated hole shape when viewed from above. This also helps to reduce or avoid the imperfections identified at the outset.

FIG. 6 shows the jet nozzle 1 in a top view of the flange portion 9. The cross-sectional area of the light channel 3, which is orthogonal to the longitudinal direction of the jet nozzle 1, also deviates from a circular shape in the region of the flange portion 9 and is stretched in the direction of advance 2. The elongation of the cross-sectional area can decrease from the distal region 8 to the flange portion 9. In the region of the mouth 6 of the nozzle, the cross-sectional area can be stretched in such a way that it is at least 1.5 times larger in the direction of advance, in particular at least twice as large as transverse to the direction of advance. The flange portion 9 has such a radial extension that the injector guides 19 are not visible from the top view of the proximal region 10.

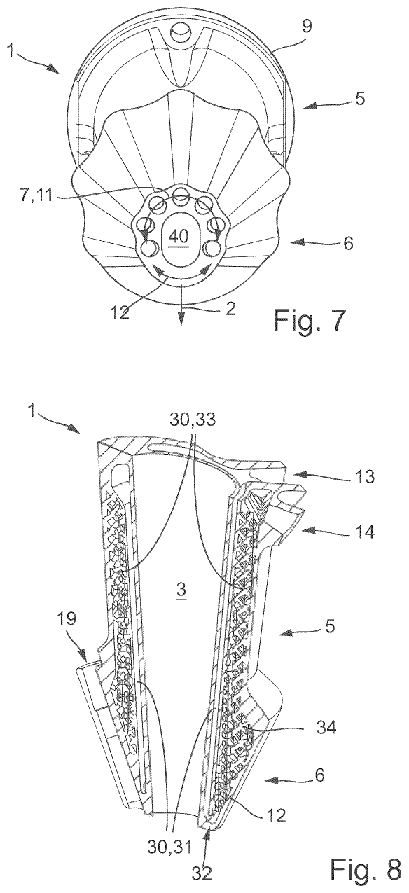

FIG. 7 shows the jet nozzle 1 in a further perspective view. The mouth 6 of the nozzle has a curved funnel shape. The injector guides 19, into which the powder injectors 16 can be inserted, are formed within the individual curvatures. In the direction of advance 2, the light channel is stretched in a way that deviates from a circular shape to achieve the advantages according to the disclosure. In the circumferential direction around the light channel 3, the mouth 6 of the nozzle has the powder unit 7. This extends in the circumferential direction around the light channel 3 along the powder portion 11, which is adjoined by the powder-free advance portion 12.

FIG. 8 shows a perspective sectional view of the jet nozzle 1. The light channel 3 has a conical shape, so that the cross-sectional area of the light channel 3 running orthogonal to the longitudinal direction of the jet nozzle 1 is smaller in the distal region 8 than in the proximal region 10. The coolant inlet 13 and the coolant outlet 14 are arranged in the proximal region 10 of the jet nozzle 1 and protrude in a radial direction from the jet nozzle 1. FIG. 8 shows a sectional view of an injector guide 19. This is arranged in the powder portion 11. No injector guide 19 for guidance of the jet of powder is provided in the advance portion 12. The jet nozzle 1 has a cooling system 30. A cooling medium, for example water, is fed back to a radially inner cooling chamber 31 via the coolant inlet 13 in the proximal region 10. The cooling medium can be distributed in the proximal region 10 in the circumferential direction around the light channel 3. The cooling medium runs from the proximal region 10 to the mouth 6 of the nozzle. The radially inner cooling chamber 31 is formed at least in the mouth 6 of the nozzle. It can extend from the distal region 8 to the proximal region 10 and be designed in the form of an annular gap segment that extends around light channel 3. In the region of the mouth 6 of the nozzle, the radially inner cooling chamber 31 extends circumferentially about the light channel 3. The radially inner cooling chamber 31 has a constant width in the radial direction in the region of the mouth 6 of the nozzle and is concentric to the light channel 3 in a cross-sectional area extending orthogonally to a longitudinal direction of the jet nozzle 1.

A transition 32 between the radially inner cooling chamber 31 and a radially outer cooling chamber 33 is provided in the distal region 8. The radially outer cooling chamber 33 has a radial width that decreases towards the distal region 8 in the radial direction in the region of the mouth 6 of the nozzle. The radially outer cooling chamber 33 extends from the distal region 8 to the proximal region 10, where it feeds the heated coolant to the coolant outlet 14. The transition 32 between the radially inner cooling chamber 31 and the radially outer cooling chamber 33 is arranged in the advance portion 12. The advance portion 12 has no injector guides 19 for guidance of the jet of powder beam, which means that there is sufficient installation space for the transition 32.

The radially outer cooling chamber 33 has a cooling structure to increase the surface area. The cooling structure can be produced by means of an additive manufacturing process. It ensures that the cooling medium comes into contact with as much surface area as possible when returning from the distal region 8 to the proximal region 10 to promote heat dissipation. The cooling structure is optimized to cause the lowest possible pressure loss of the cooling medium. This can be achieved by a honeycomb structure 34, as shown in FIG. 8.

FIG. 9 shows the jet nozzle 1 having an absorption portion 40. This is designed to absorb back-reflected radiation of the laser beam from the workpiece. The absorption portion 40 extends from the distal region 8 to the proximal region 10. It thus helps to protect the laser optics from back-reflected radiation. The absorption portion 40 has a serrated structure. This forms the absorption surfaces facing the distal region 8. The absorption portion is provided in the area of the advance portion 12. The absorption portion 40 can be formed of the same material as the rest of the jet nozzle 1. It can also have a coating. The laser radiation absorbed by the absorption portion 40 can be dissipated by the cooling system 30 interacting with the absorption portion 30.

FIG. 10 shows the jet nozzle 1 with a workpiece 100. The laser beam 110 extends along a longitudinal axis 43 of the light channel 3. The longitudinal axis 43 of the light channel 3 is inclined relative to a perpendicular of the workpiece surface 41. Due to this inclination, reflected laser radiation 150 is directed onto the absorption portion 40. The inclination of the longitudinal axis 43 of the light channel 3 relative to the perpendicular of the workpiece surface 41 is selected such that the absorption portion 40 absorbs as much reflected laser radiation as possible. The inclination is between 2° and 20°, in particular between 3° and 10°. To achieve the inclination, it is possible to incline the jet nozzle 1 relative to the workpiece 100 or to incline the workpiece 100 relative to the jet nozzle 1. A surface roughness of the absorption surfaces of the absorption portion 40 is between 5 μm and 100 μm, in particular between 50 μm and 50 μm. The absorption portion 40 can also be provided with an absorbent coating that promotes absorption.

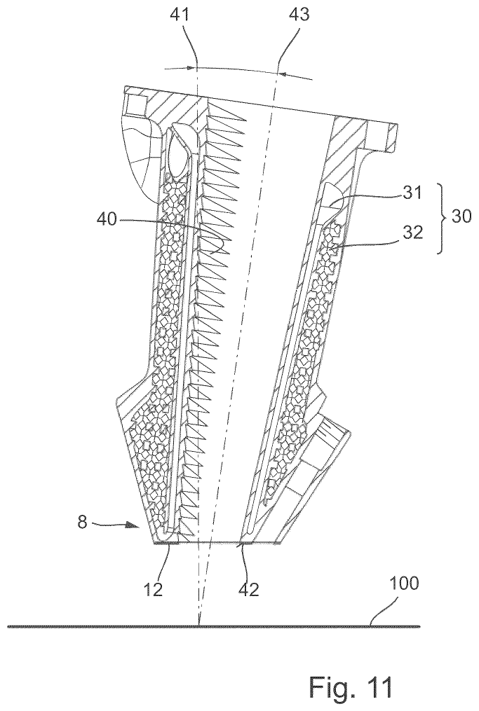

FIG. 11 shows the jet nozzle 1, in which an end face 42 of the jet nozzle 1 runs at an angle to the longitudinal axis 43 of the light channel 3 so that the end face 42 runs plane-parallel to the workpiece 100. This increases the distance from the mouth 6 of the nozzle to the workpiece 100. This also reduces the thermal load on the mouth 6 of the nozzle. In addition, the angled end face 42 enables improved shielding gas coverage of the workpiece 100. This is because the plane-parallel surface of the end face 42 allows a shielding gas flow to emerge orthogonally to the workpiece 100.

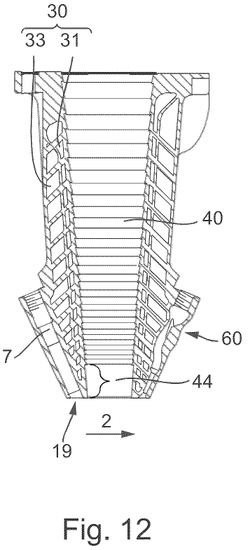

FIG. 12 shows a longitudinal sectional view through a jet nozzle 1 with a smooth inner end portion 44. The jet nozzle 1 can form a smooth inner end portion 44 as the distal surface of the light channel 3. The smooth inner end portion 44 facilitates better cleaning of the inner mouth 6 of the nozzle. The absorption portion 40 extends proximally from the smooth inner end portion 44. The absorption portion 40 can further extend completely along the circumferential direction around the light channel 3, i.e., around 360°. The absorption capacity of the jet nozzle 1 thus does not depend on a specific direction of advance.

In FIG. 12, the powder unit 7 is provided at a rear region in the direction of advance 2, which forms the powder portion 11 and through which the injector guides 19 extend. The injector guides 19 are adapted to each accommodate a powder injector 16. The process gas unit 60 can be provided at a front region in the direction of advance 2, which forms the process gas portion 61 and through which distribution arms for the process gas extend. A distribution arm can accommodate an additional injector. Alternatively, the process gas is directed directly from the distribution arms to the material surface. The distribution arms have a curved shape along their longitudinal direction. The jet nozzle 1 has the cooling system 30 with the radially inner cooling chamber 31 and the radially outer chamber 33. Due to the design of the advance portion 12 as a process gas portion, the radially outer cooling chamber 33 surrounds the distribution arms 24 in the front region of the mouth 6 of the nozzle in the direction of advance 2. The process gas can therefore contribute to the heat management of the jet nozzle 1.

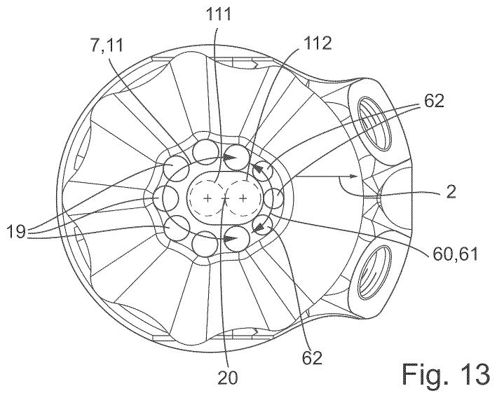

FIG. 13 shows the jet nozzle 1 in a top view of the distal region 8. The primary beam 111 and the secondary beam 112 are guided within the light channel 3. The secondary beam 112 is in front of the primary beam 111 in the direction of advance 2 and does not interact with a powder caustic, as described in more detail in connection with FIG. 5. When the laser beams interact with the material surface and the jet of powder, a vapor plume can form between the jet nozzle 1 and the workpiece 100. If this is not contained, it can interact with at least one laser beam and/or the unprocessed and/or processed material surface in an undesirable manner. In the region adjacent to the powder portion 11, the advance portion 12 can therefore be designed as a process gas portion 61. This is formed by the process gas unit 60 being arranged radially outside the light channel 3, which directs the process gas onto the workpiece. The process gas portion 61 can prevent undesired spreading of the vapor plume and thus contribute to precise workpiece processing with a robust jet nozzle design. The process gas portion 61 can form at least one, in the present case three, outlet openings 62. The outlet openings 62 are formed on one end face of the jet nozzle 1. An additional injector for supplying the process gas without additional material can be inserted into the respective outlet opening 62. An inner diameter of the outlet opening 62 can be smaller than an inner diameter of the injector guides 19. The process gas portion 61 also prevents powder particles from adhering to the end face of the jet nozzle 1. In this respect, the process gas portion 61 also increases the service life of the jet nozzle 1. The process gas portion 61 and the powder portion 11 can be provided circumferentially around the elongated hole formed by the light channel 3. Thus, the primary beam 111 and the secondary beam 112 are completely within the beams composed of the jet of powder and the process gas jet.

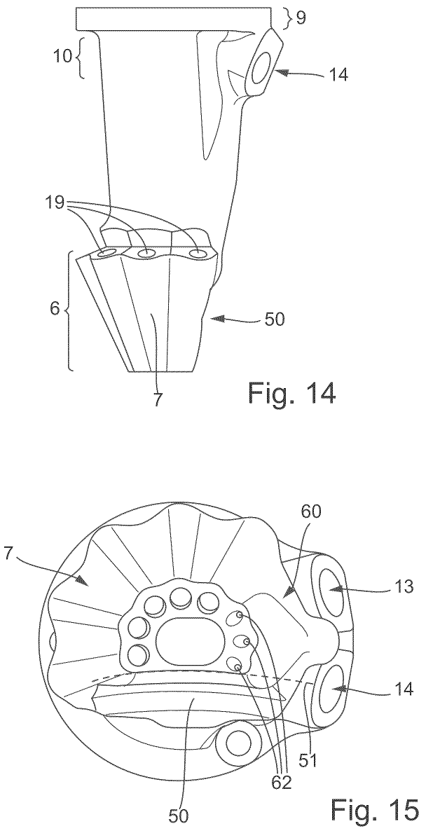

FIG. 14 shows a further embodiment of the jet nozzle 1. The mouth 6 of the nozzle has a chamfer 50, through which a part of the mouth 6 of the nozzle is cut off. The chamfer 50 has the effect that the powder portion 11 and the advance portion 12 without a powder portion are cut off in the circumferential direction around the light channel 3. The chamfer 50 reduces the volume of the mouth 6 of the nozzle compared to the embodiment in which there is no chamfer 50. This ensures that the mouth 6 of the nozzle takes up less installation space. The jet nozzle 1 with the chamfer 50 can be used, for example, to coat a brake disk. The brake disk can have a mount that protrudes axially from the functional surface to be coated. The chamfer 50 ensures that the jet nozzle 1 can move flexibly on the functional surface to be coated and can be moved close to the holder. The chamfer 50 can be essentially flat and run in a plane that is inclined relative to the longitudinal direction of the jet nozzle. The chamfer 50 represents a boundary surface of the mouth 6 of the nozzle in which a powder unit 7 is not provided. In the distal region 8, the chamfer 50 is arranged so close to the light channel 3 that no injector guides 19 are provided on an end face of the jet nozzle 1 facing the workpiece in the region of the chamfer 50.

FIG. 15 shows the jet nozzle 1 with the chamfer 50 in a top view. The chamfer 50 can run in the distal region 8 in the manner of a passant 51 on the elongated hole. The passant 51 defines the orientation of the chamfer 50 on the mouth 6 of the nozzle. In the end face of the jet nozzle 1 facing the workpiece, the passant 51 runs along a straight line or an arc that neither intersects nor touches the elongated hole. The distance of the passant 51 from the center 20 of the light channel 3 is greater than the distance of the corresponding section of the elongated hole from the center 20 of the light channel 3. The distance between the passant 51 and an outer edge of the elongated hole is selected in such a way that the wall thickness therebetween ensures sufficient strength and resilience of the jet nozzle 1.

The orientation of the passant 51 and thus the orientation of the chamfer 50 at the mouth 6 of the nozzle can be varied for different jet nozzles 1 depending on the respective application. For example, the passant 51 can run in the direction of advance 2. In this case, the passant 51 runs along the elongation of the cross-sectional area of the light channel 3. The passant 51 thus runs along the long side of the elongated hole. Alternatively, the passant 51 can run transversely to the direction of advance 2, for example. In this case, the passant 51 runs transversely to the extension of the cross-sectional area of the light channel 3. The passant 51 thus runs along the partial circular section of the elongated hole. Further alternatively, the passant 51 can, for example, run at an angle to the direction of advance 2 that lies between a course along the direction of advance 2 and transverse to the direction of advance 2. In this case, the passant 51 runs along the transition section between the long side of the elongated hole and the partial circular section of the elongated hole. The course of the passant 51 determines the orientation of the chamfer 50.

In the embodiment in FIG. 15, outlet openings 62 are provided on the front side of the jet nozzle. From here, the process gas exits the process gas unit 60. In the present case, the chamfer 50 is designed such that the portion of the mouth 6 of the nozzle cut off by the chamfer comes entirely from the powder portion 11, so that the angle along which the powder portion 11 extends is reduced by the chamfer 50, while the angle along which the process gas unit 60 extends remains substantially the same.

Insofar as applicable, all individual features presented in the exemplary embodiments can be combined with one another and/or interchanged.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Jet nozzle
2 Direction of advance
3 Light channel
4 Lateral surface
5 Outer structure
6 Mouth of the nozzle
7 Powder unit
8 Distal region
9 Flange portion
10 Proximal region
11 Powder portion
12 Advance portion
13 Coolant inlet
14 Coolant outlet
15 Coupling ring
16 Powder injector
17 Inlet connection
18 Outlet connection
19 Injector guide
20 Center of the light channel
21 First powder focus
30 Cooling system
31 Radially inner cooling chamber
32 Transition
33 Radially outer cooling chamber
34 Honeycomb structure
35 Pin structure
40 Absorption portion
41 Perpendicular of the workpiece surface
42 End face
43 Longitudinal axis of the light channel
44 Inner end portion
50 Chamfer
51 Passant
60 Process gas unit
61 Process gas portion
62 Outlet opening
100 Workpiece
110 Laser beam
111 Primary beam
112 Secondary beam
120 Powdered filler material
130 Molten pool
140 Functional layer
150 Reflected laser radiation

1. A jet nozzle for laser cladding along a direction of advance, the jet nozzle comprising:
a light channel for conducting at least one laser beam directed onto a workpiece; and
an outer structure surrounding the light channel at least in sections, the outer structure extending from a flange portion to a distal region that is formed by a mouth of the jet nozzle from which the at least one laser beam exits;
wherein the light channel forms an absorption portion for absorbing back-reflected radiation of the at least one laser beam from the workpiece.

2. The jet nozzle according to claim 1, wherein
the absorption portion extends from above the distal region to a proximal region adjoining the flange portion.

3. The jet nozzle according to claim 1, wherein
the absorption portion has a serrated structure which forms absorption surfaces facing the distal region.

4. The jet nozzle according to claim 1, further comprising:
a powder unit arranged radially outside the light channel in the outer structure for conducting at least one jet of powder which is to be applied to the workpiece, wherein the powder unit forms a powder portion at the mouth of the jet nozzle in a circumferential direction around the light channel, which is followed in the circumferential direction by an advance portion that is free of the power unit.

5. The jet nozzle according to claim 4, wherein
the absorption portion is arranged at least in the advance portion circumferentially in the circumferential direction.

6. The jet nozzle according to claim 1, wherein
the absorption portion extends completely around the light channel in a circumferential direction.

7. The jet nozzle according to claim 1, wherein
a longitudinal axis of the light channel along which the laser beam runs, is inclined relative to a normal of a surface of the workpiece in order to increase absorption of the back-reflected radiation by the absorption portion.

8. The jet nozzle according to claim 7, wherein
an end face of the jet nozzle runs at an angle to the longitudinal axis of the light channel along which the laser beam runs so that the end face is provided running plane-parallel to the surface of the workpiece.

9. The jet nozzle according to claim 1, wherein
a surface of the absorption portion increases in a circumferential direction around the light channel from the mouth of the jet nozzle towards the flange portion.

10. The jet nozzle according to claim 1, wherein
the jet nozzle is inclined relative to the workpiece, so that absorption of the back-reflected radiation by the absorption portion is capable of being controlled by an inclination.

11. The jet nozzle according to claim 1, wherein
the absorption portion comprises an absorbent coating.

12. The jet nozzle according to claim 1, wherein the jet nozzle is manufactured by an additive manufacturing process and comprises copper or a copper alloy.

13. The jet nozzle according to claim 1, wherein
the mouth of the jet nozzle has a chamfer by which a part of the mouth of the jet nozzle is cut off, wherein the chamfer is substantially planar and extends in a plane that is inclined relative to a longitudinal direction of the jet nozzle.

14. A system comprising a jet nozzle according to claim 1 and the workpiece, wherein
the jet nozzle is inclined relative to the workpiece such that a longitudinal axis of the light channel along which the laser beam runs deviates from a normal of a surface of the workpiece, so that absorption of the back-reflected radiation by the absorption portion is increased.

15. The system according to claim 14, wherein
an inclination of the jet nozzle relative to the workpiece is between 2° and 45°.
